(19) United States
(12) Patent Application Publication
(10) Pub. No.: US 2025/0330998 A1
(43) Pub. Date: Oct. 23, 2025

(54) METHOD AND APPARATUS FOR RECEIVING DATA BASED ON DCI FOR MULTIPLE CELLS

(71) Applicant: Samsung Electronics Co., Ltd., Suwon-si, Gyeonggi-do (KR)

(72) Inventors: Jingxing FU, Beijing (CN); Feifei SUN, Beijing (CN)

(21) Appl. No.: 18/870,571

(22) PCT Filed: Jun. 22, 2023
(86) PCT No.: PCT/KR2023/008672

§ 371 Date: Nov. 29, 2024

(30) Foreign Application Priority Data
Jun. 24, 2022 (CN) 202210730921.8

(51) Int. Cl. H04W 72/232; H04L 5/00; H04W 72/12

(52) U.S. Cl. CPC H04W 72/232; H04L 5/0044; H04W 72/12

(57) ABSTRACT

The disclosure relates to a 5G or 6G communication system for supporting a higher data transmission rate. A method performed by a user equipment (UE) in a wireless communication system is provided. The method comprises receiving, from a base station, first downlink control information (DCI) for scheduling multiple physical downlink shared channels (PDSCHs) on multiple cells based on a first search space set and receiving, from the base station, the multiple PDSCHs on the multiple cells based on the first DCI. The first search space set for the first DCI is different from a search space set for a DCI scheduling a PDSCH on one cell.

### TECHNICAL FIELD

The present disclosure relates generally to wireless communication systems and, more specifically, to a method and a apparatus for receiving data based on a downlink control information (DCI) for multiple cells.

### BACKGROUND ART

5G mobile communication technologies define broad frequency bands such that high transmission rates and new services are possible, and can be implemented not only in “Sub 6 GHZ” bands such as 3.5 GHz, but also in “Above 6 GHZ” bands referred to as mmWave including 28 GHZ and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

According to an embodiment, a method performed by a user equipment (UE) in a wireless communication system is provided. The method comprises receiving, from a base station, first downlink control information (DCI) for scheduling multiple physical downlink shared channels (PDSCHs) on multiple cells based on a first search space set and receiving, from the base station, the multiple PDSCHs on the multiple cells based on the first DCI. The first search space set for the first DCI is different from a search space set for a DCI scheduling a PDSCH on one cell.

According to an embodiment, a user equipment (UE) in a wireless communication system is provided. The UE comprises a transceiver and a controller coupled with the transceiver and configured to receive, from a base station, first downlink control information (DCI) for scheduling multiple physical downlink shared channels (PDSCHs) on multiple cells based on a first search space set and receive, from the base station, the multiple PDSCHs on the multiple cells based on the first DCI. The first search space set for the first DCI is different from a search space set for a DCI scheduling a PDSCH on one cell.

According to an embodiment, a method performed by a base station in a wireless communication system is provided. The method comprises transmitting, to a user equipment (UE), first downlink control information (DCI) for scheduling multiple physical downlink shared channels (PDSCHs) on multiple cells and transmitting, to the UE, the multiple PDSCHs on the multiple cells based on the first DCI. A first search space set for the first DCI is different from a search space set for a DCI scheduling a PDSCH on one cell.

According to an embodiment, a base station in a wireless communication system is provided. The base station comprises a transceiver and a controller coupled with the transceiver and configured to transmit, to a user equipment (UE), first downlink control information (DCI) for scheduling multiple physical downlink shared channels (PDSCHs) on multiple cells and transmit, to the UE, the multiple PDSCHs on the multiple cells based on the first DCI. A first search space set for the first DCI is different from a search space set for a DCI scheduling a PDSCH on one cell.

### BRIEF DESCRIPTION OF DRAWINGS

The proposed system and method are illustrated in the accompanying drawings, throughout which like reference letters indicate corresponding parts in the various figures. The embodiments herein will be better understood from the following description with reference to the drawings, in which:

FIG. 1 illustrates an example wireless network according to various embodiments of the present disclosure;

FIG. 2A illustrates an example wireless transmission path according to various embodiments of the present disclosure;

FIG. 2B illustrates an example wireless reception path according to various embodiments of the present disclosure;

FIG. 3A illustrates an example user equipment according to various embodiments of the present disclosure;

FIG. 3B illustrates an example base station according to various embodiments of the present disclosure;

FIG. 4 is a flowchart illustrating a method performed by a user equipment in a communication system according to an exemplary embodiment of the present disclosure;

FIG. 5 is a flowchart illustrating a method performed by a base station in a communication system according to an exemplary embodiment of the present disclosure;

FIG. 6 is a block diagram illustrating a user equipment according to an exemplary embodiment of the present disclosure; and

FIG. 7 is a block diagram illustrating a base station according to an exemplary embodiment of the present disclosure.

### BEST MODE FOR CARRYING OUT THE INVENTION

Embodiments of the present disclosure are described below in connection with accompanying drawings in the present disclosure. It is to be understood that the embodiments set forth below in connection with the accompanying drawings are exemplary descriptions for explaining the technical solutions of the embodiments of the present disclosure and do not constitute a limitation of the technical solutions of the embodiments of the present disclosure.

It will be understood by those skilled in the art that, unless specifically stated, the singular forms “one”, “a”, “said” and “the” used herein may also include the plural form. It should be further understood that the terms “includes” and “comprises” as used in the embodiments of the present disclosure mean that the corresponding features may be implemented as the features, information, data, steps, operations, elements and/or components presented, but do not exclude the implementation of other features, information, data, steps, operations, elements, components and/or combinations thereof supported in the art. It should be understood that when we refer to an element being “connected” or “coupled” to another clement, the component may be directly connected or coupled to the other element, or it may refer to the element and the other clement being connected through an intermediate element. In addition, the “connect” or “couple” as used herein may include wireless connection or wireless coupling. The term “and/or” as used herein indicates at least one of the items defined by the term, for example, “A and/or B” may be implemented as “A”, or “B”, or “A and B”. When describing multiple (two or more) items, if the relationship between the multiple items is not explicitly defined, the multiple items may refer to one, more than one, or all of the multiple items, for example, the description “a parameter A includes A1, A2, A3” may be implemented that the parameter A includes A1 or A2 or A3, or that the parameter A includes at least two of the three parameters A1, A2, A3.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beam forming, massive multiple-input multiple-output (MIMO), full-dimensional MIMO (FD-MIMO), array antenna, analog beam forming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

How to better improve the existing wireless communication methods and better meet the communication needs is a technical problem that technicians in this field have been working on.

The purpose of the present disclosure is to be able to solve at least one of the technical defects in the existing communication methods to better meet the communication needs. In order to achieve this purpose, the technical solutions proposed in the present disclosure are as follows.

According to a first aspect of the embodiments of the present disclosure, a method performed by an user equipment (UE) in a communication system is proposed, the method comprises: receiving configuration information transmitted by a base station, wherein, the configuration information comprises information for indicating a scheduling mode of a PDSCH and/or PUSCH; detecting downlink control information (DCI) according to the configuration information; receiving the PDSCH and/or PUSCH scheduled by the detected DCI, according to the detected DCI; wherein, the scheduling mode includes a first scheduling mode for representing that one DCI schedules a PDSCH and/or PUSCH of one serving cell, and/or a second scheduling mode for representing that one DCI simultaneously schedules a PDSCH and/or PUSCH of at least one serving cell.

Alternatively, the detecting the DCI according to the configuration information comprises: detecting the DCI according to the configuration information, for each of multiple downlink BWPs.

Alternatively, the detecting the DCI according to the configuration information comprises: detecting the DCI according to the configuration information, for each search space of a downlink BWP.

Alternatively, a scheduling configuration in which one DCI simultaneously schedules a PDSCH and/or PUSCH of at least one serving cell is configured for each of the multiple downlink BWPs.

Alternatively, a scheduling configuration in which one DCI simultaneously schedules a PDSCH and/or PUSCH of at least one serving cell is configured for each search space of the downlink BWP.

Alternatively, the configuration information further comprises: the number of serving cells whose PDSCHs and/or PUSCHs are simultaneously scheduled by one DCI, and/or DCI format information; wherein, the DCI format information includes format information for indicating a DCI format in which one DCI simultaneously schedules the PDSCHs and/or PUSCHs of the number of serving cells.

Alternatively, the number of serving cells whose PDSCHs and/or PUSCHs are simultaneously scheduled by one DCI is at least one of: the number of serving cells configured for the UE, the maximum number of serving cells configured for the UE, and a range of the number of serving cells configured for the UE.

Alternatively, the detecting the DCI according to the configuration information comprises: calculating a payload size of the DCI format, according to the number of serving cells whose PDSCHs and/or PUSCHs are simultaneously scheduled by one DCI included in the configuration information; and detecting the DCI having the DCI format in a search space, according to the payload size of the DCI format and the format information.

According to a second aspect of the embodiments of the present disclosure, a method performed by a base station in a communication system is proposed, the method comprises: determining a scheduling mode in which an user equipment (UE) schedules a PDSCH and/or PUSCH; transmitting configuration information to the UE, the configuration information comprising information for indicating the scheduling mode, wherein, the scheduling mode includes a first scheduling mode for representing that one DCI schedules a PDSCH and/or PUSCH of one serving cell, and/or a second scheduling mode for representing that one DCI simultaneously schedules a PDSCH and/or PUSCH of at least one serving cell.

Alternatively, the method further comprises: configuring and transmitting DCI according to the configuration information, for each of multiple downlink BWPs.

Alternatively, the method further comprises: configuring and transmitting DCI according to the configuration information, for each search space of a downlink BWP.

Alternatively, a scheduling configuration in which one DCI simultaneously schedules a PDSCH and/or PUSCH of at least one serving cell is configured for each of the multiple downlink BWPs.

Alternatively, a scheduling configuration in which one DCI simultaneously schedules a PDSCH and/or PUSCH of at least one serving cell is configured for each search space of the downlink BWP.

Alternatively, the configuration information further comprises: the number of serving cells whose PDSCHs and/or PUSCHs are simultaneously scheduled by one DCI, and/or DCI format information; wherein, the DCI format information includes format information for indicating a DCI format in which one DCI simultaneously schedules the PDSCHs and/or PUSCHs of the number of serving cells.

Alternatively, the number of serving cells whose PDSCHs and/or PUSCHs are simultaneously scheduled by one DCI is at least one of: the number of serving cells configured for the UE, the maximum number of serving cells configured for the UE, and a range of the number of serving cells configured for the UE.

According to a third aspect of the embodiments of the present disclosure, an user equipment is provided, the user equipment including: a transceiver; and a processor coupled to the transceiver and configured to perform the above method performed by an UE.

According to a fourth aspect of the embodiments of the present disclosure, a base station is provided, the base station including: a transceiver; and a processor, coupled to the transceiver and configured to perform the above method performed by a base station.

According to a fifth aspect of the embodiments of the present disclosure, a computer-readable storage medium storing instructions is provided, the instructions, when run by at least one processor, cause the at least one processor to perform the above method performed by a UE or perform the above method performed by a base station

The technical solutions provided by the embodiments of the present disclosure brings at least the following beneficial effect: the resources occupied by a PDCCH may be saved, when a DCI format in which one DCI simultaneously schedules a PDSCH/PUSCH of at least one serving cell is used to schedule the PDSCH/PUSCH of at least one serving cell. In addition, according to the number of serving cells that may be scheduled by the UE when configured in subcarrier spaces of different BWPs, the appropriate number of serving cells that may be scheduled are selected, so as to save resources occupied by the PDCCH as much as possible.

The beneficial effects brought by the technical solutions provided by the embodiments of the present disclosure will be described later in connection with specific optional embodiments, or may be known from the description of the embodiments, or may be learned from the implementation of the embodiments.

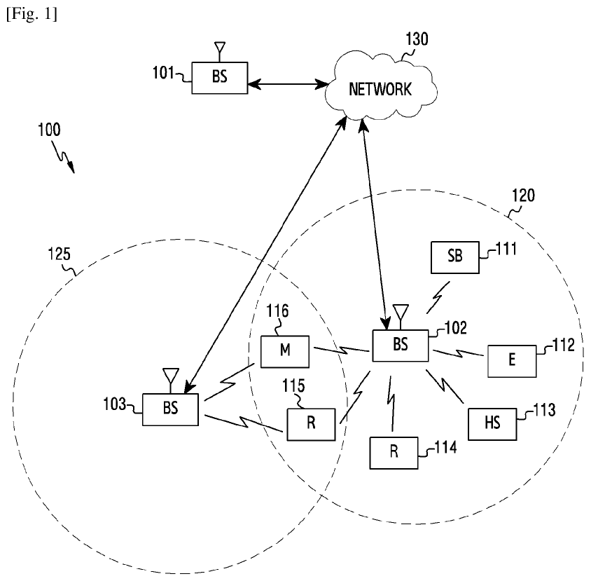

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

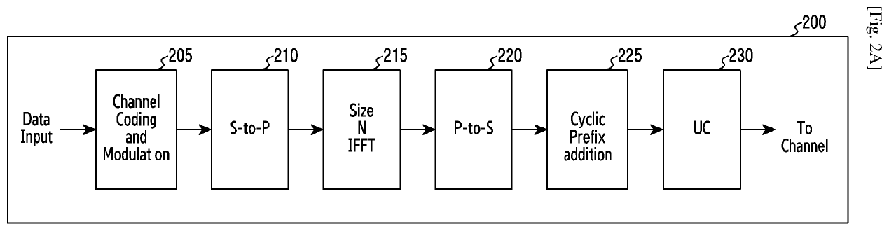

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

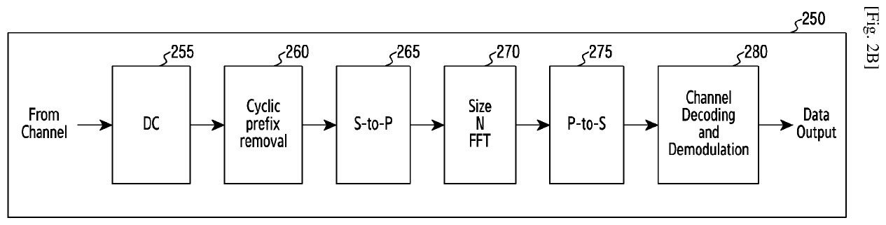

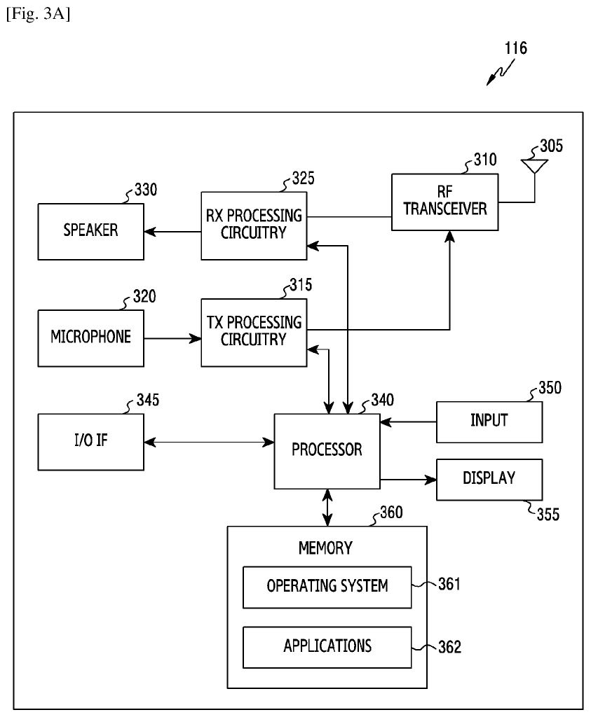

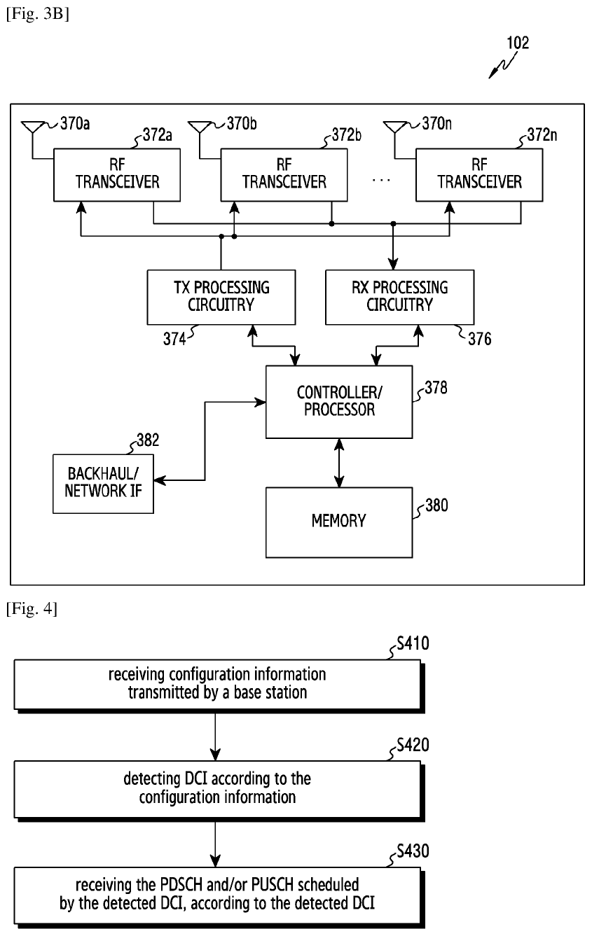

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

It may be understood that the solutions provided by the embodiments of the present disclosure may be applicable to, but not limited to, the wireless network described above.

In a communication system, a transmission from a base station to an user equipment (UE) is referred to as a downlink, and a transmission from an UE to a base station is referred to as an uplink. The downlink corresponds to a downlink transmission (which may also be called downlink sending or downlink emitting, etc.), and the downlink transmission includes at least one of transmissions of a downlink channel and a downlink signal, where the downlink channel includes a Physical Downlink Shared Channel (PDSCH), and a Physical Downlink Control Channel (PDCCH), and the downlink signal may include but is not limited to a downlink reference signal. Among them, the PDSCH is scheduled by Downlink Control Information (DCI) in the PDCCH.

An uplink transmission includes at least one of transmissions of an uplink channel and an uplink signal, wherein the uplink channel includes a Physical Uplink Shared Channel (PUSCH), a Physical Uplink Control Channel (PUCCH), and a Physical Random Access Channel (PRACH), and the uplink signal may include but is not limited to an uplink reference signal. Among them, the PUSCH is scheduled by the Downlink Control Information (DCI) in the PDCCH.

A PDSCH/PUSCH may be scheduled by a PDCCH of a same serving cell as the PDSCH/PUSCH, called self-carrier-scheduling, or the PDSCH/PUSCH may be scheduled by a PDCCH of a different serving cell from the PDSCH/PUSCH, called cross-carrier-scheduling.

The technical solutions of the present disclosure and how the technical solutions of the present disclosure solve the above technical problem are described in detail below in specific embodiments. The following specific embodiments may be combined with each other, and the same or similar concepts or processes may not be repeated in some embodiments. The embodiments of the present disclosure are described below in conjunction with the accompanying drawings. The text and drawings in the following description are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

Currently, one PDCCH may only schedule a PDSCH and/or PUSCH of one serving cell, regardless of self-carrier-scheduling or cross-carrier-scheduling, for example, the UE is configured with two serving cells, i.e., serving cell 1 and serving cell 2 respectively, and a PDCCH of serving cell 1 schedules a PDSCH and/or PUSCH of serving cell 1, which is called self-carrier-scheduling, and the PDCCH of serving cell 1 schedules a PDSCH and/or PUSCH of serving cell 2, which is called cross-carrier-scheduling. A PDSCH and/or PUSCH of one serving cell can only be scheduled by a PDCCH of one serving cell, that is, the PDSCH and/or PUSCH of one serving cell is self-carrier-scheduled by the PDCCH of this serving cell, or a PDSCH and/or PUSCH of one serving cell is cross-carrier-scheduled by a PDCCH of another serving cell, and DCI in one PDCCH can only schedule a PDSCH and/or PUSCH of one serving cell at the same time.

For this, in order to reduce the resources occupied by the PDCCH scheduling the PDSCH and/or PUSCH, the present disclosure proposes a scheme for DCI in one PDCCH simultaneously scheduling a PDSCH and/or PUSCH of at least one serving cell. This is described below with reference to the attached drawings.

FIG. 4 illustrates a flowchart of a method performed by an user equipment (UE) in a communication system according to an exemplary embodiment of the present disclosure. As illustrated in FIG. 4, the method may include step S410 to S430.

Referring to FIG. 4, At step S410, configuration information transmitted by a based station is received. For example, the UE in a wireless communication system may receive configuration information from the base station,

According to an embodiment, the configuration information may include information for indicating a scheduling mode of a PDSCH and/or PUSCH. The scheduling mode includes a first scheduling mode for representing (or indicating) that one DCI schedules a PDSCH and/or PUSCH of one serving cell, and/or a second scheduling mode for representing that one DCI simultaneously schedules a PDSCH and/or PUSCH of at least one serving cell. By using the second scheduling mode in which one DCI simultaneously schedules a PDSCH and/or PUSCH of at least one serving cell, the resources occupied by a PDCCH may be saved as much as possible.

According to an embodiment, the configuration information may further comprise the number of serving cells whose PDSCHs and/or PUSCHs are simultaneously scheduled by one DCI, and/or DCI format information. For example, the DCI format information may include format information for indicating a DCI format.

According to an embodiment, in case that the scheduling mode is the second scheduling mode, the format information is used to indicate a DCI format in which one DCI simultaneously schedules the PDSCHs and/or PUSCHs of the number of serving cells. That is, at this time, the UE may further obtain the above number and the above DCI format information from the configuration information to facilitate subsequent DCI detection.

According to an embodiment, in case that the scheduling mode is the first scheduling mode, the configuration information does not comprise the number of serving cells whose PDSCHs and/or PUSCHs are simultaneously scheduled by one DCI, but includes DCI format information, and at this time, format information included in the DCI format information indicates a DCI format in which one DCI schedules one PDSCH and/or PUSCH.

According to an embodiment, regardless of whether the scheduling mode is the first scheduling mode or the second scheduling mode, the DCI format information may further include a payload size of the DCI format. The payload size may be used by UE for the detection operation in step S420 described below. Specifically, the payload size can be used to decode the received PDCCH. However, in the present disclosure, in case that the scheduling mode is the second scheduling mode, the DCI format information may not include the payload size of the DCI format, and at this time, the payload size of the DCI format may be calculated, according to the number of serving cells whose PDSCHs and/or PUSCHs are simultaneously scheduled by one DCI, included in the configuration information,

According to an embodiment, The number of serving cells whose PDSCHs and/or PUSCHs are simultaneously scheduled by one DCI is at least one of the number of serving cells configured for the UE, the maximum number of serving cells configured for the UE, or a range of the number of serving cells configured for the UE.

For example, in case that the number of serving cells configured for the UE is 4, the UE uses 4 to calculate the payload size of the DCI format. In case that the maximum number of serving cells configured for the UE is 5, the UE uses 5 to calculate the payload size of the DCI format. In case that the range of the number of serving cells configured for the UE is {3,4}, the UE selects the maximum number of 4 in the range to calculate the payload size of the DCI format.

At step S420, the DCI may be detected based on (or, according to) the configuration information. This is described with examples below.

For example, in case that the UE is configured with M (M is a positive integer) serving cells, the PDSCH and/or PUSCH of one serving cell of the M serving cells is self-carrier-scheduled by the PDCCH of this serving cell, and the PDSCHs and/or PUSCHs of the remaining M-1 serving cells are cross-carrier-scheduled by the PDCCH of the above serving cell. For example, in case that the UE is configured with four serving cells (i.e., serving cell 1, serving cell 2, serving cell 3 and serving cell 4), the PDSCH and/or PUSCH of the serving cell 1 is self-carrier-scheduled by the PDCCH of the serving cell 1, and the PDSCHs and/or PUSCHs of the serving cell 2, the serving cell 3 and the serving cell 4 are cross-carrier-scheduled by the PDCCH of the serving cell 1. In the following, a serving cell transmitting a PDCCH is called a scheduling cell, and a serving cell transmitting a PDSCH and/or PUSCH is called a scheduled cell.

In this case, two different methods may be used to determine whether the scheduling mode of the UE is the first scheduling mode or the second scheduling mode. That is, there is two methods for determining whether the scheduling mode is the second scheduling mode in which one DCI simultaneously schedules a PDSCH and/or PUSCH of at least one serving cell, or the first scheduling mode in which one DCI schedules a PDSCH and/or PUSCH of one serving cell.

The two methods described below is coupled with each other. That is the UE and/or the base station determine the scheduling mode of the UE based on the Method 1 and/or Method 2.

### Method 1

Whether a scheduling mode in which one DCI simultaneously schedules a PDSCH and/or PUSCH of at least one serving cell is configured in a search space in a BWP of each scheduling cell is independent. Accordingly, the detecting the DCI according to the configuration information comprises detecting the DCI according to the configuration information, for each of multiple downlink BWPs. For example, the detecting the DCI based on the configuration information (e.g., S420) comprises detecting the DCI based on the configuration information for each of a plurality of downlink BWPs.

For example, in the above example, the UE is configured with four serving cells, namely, serving cell 1, serving cell 2, serving cell 3 and serving cell 4 respectively. The serving cell 1 is self-carrier-scheduled by the serving cell 1. The serving cell 2, the serving cell 3 and the serving cell 4 are cross-carrier-scheduled by the serving cell 1. The serving cell 1 is configured with multiple BWPs, for example, two downlink BWPs, i.e., BWP-1 and BWP-2, respectively. In case that BWP-1 of the serving cell 1 is in an activation state, the UE is configured with multiple search spaces through one signaling, such as search space-1 and search space-2. In this search space-1 and search space-2, the UE is configured to detect DCI having a DCI format DCI 1-X, where DCI 1-X is a DCI format in which one DCI simultaneously schedules a PDSCH and/or PUSCH of at least one serving cell, and this DCI format (e.g., DCI 1-X) may also have other names, and the present disclosure does not limit to this. The DCI having this DCI format (e.g., DCI 1-X) may simultaneously schedule a PDSCH and/or PUSCH of at least one serving cell of the serving cell 1, the serving cell 2, the serving cell 3 and the serving cell 4.

Herein, the detecting the DCI according to the configuration information may comprise calculating a payload size of the DCI format, according to the number of serving cells whose PDSCHs and/or PUSCHs are simultaneously scheduled by one DCI included in the configuration information and detecting the DCI of the DCI format in a search space, according to the payload size of the DCI format and the format information in the DCI format information.

According to an embodiment, the process of the UE detecting the DCI having the DCI format DCI 1-X is as follows:

In case that the UE determines that the scheduling mode is the second scheduling mode based on (or, according to) the received configuration information, the UE may obtain (or, identify) the number of serving cells whose PDSCHs and/or PUSCHs are simultaneously scheduled by one DCI and DCI format information from the configuration information. The UE may determine that the DCI format is DCI 1-X based on (or, according to) the format information in the DCI format information. At this time, in case that the DCI format information includes a payload size of the DCI format, the UE may use the payload size and the above format information to detect the DCI having the DCI 1-X format in the search space. In case that the DCI format information does not includes the payload size of the DCI format, the UE may calculate the payload size of the DCI format based on (or, according to) the number of serving cells whose PDSCHs and/or PUSCHs are simultaneously scheduled by one DCI included in the configuration information, and then use the payload size and the above format information to detect the DCI having the DCI 1-X format in the search space.

In addition, in case that BWP-2 of the serving cell 1 is in an activation state, the UE is configured with search space-3 and search space-4 through another signaling. In this search space-3 and search space-4, the UE is configured to detect DCI having a DCI format DCI 1-1, where DCI 1-1 is a DCI format in which one DCI schedules a PDSCH and/or PUSCH of one serving cell. Here, the UE is not configured to detect the DCI format DCI 1-X.

For example, the process of the UE detecting the DCI having the DCI format DCI 1-1 is as follows:

In case that the UE determines that the scheduling mode is the first scheduling mode based on (or, according to) the received configuration information, the UE may determine the DCI format information from the configuration information, and the UE determines that the DCI format is DCI 1-1 based on (or, according to) the format information in the DCI format information. At this time, the UE may further obtain (or, identify) a payload size of the DCI format from the DCI format information, and then use the payload size and the above format information to detect the DCI having the DCI 1-1 format in the search space.

By using the above Method 1, based on (or, according to) whether the UE has a requirement for one DCI to simultaneously schedule a PDSCH and/or PUSCH of at least one serving cell, the base station may determine whether to configure the UE to detect a DCI format in which one DCI simultaneously schedules the PDSCH and/or PUSCH of the at least one serving cell, so as to save resources occupied by a PDCCH as much as possible. This is because when the DCI format in which one DCI simultaneously schedules the PDSCH and/or PUSCH of the at least one serving cell is used to schedule the PDSCH and/or PUSCH of the at least one serving cell, the resources occupied by the PDCCH may be saved, and when the DCI format in which one DCI simultaneously schedules the PDSCH and/or PUSCH of the at least one serving cell is used to schedule a PDSCH and/or PUSCH of one serving cell, the resources occupied by the PDCCH are wasted.

### Method 2

Whether a scheduling mode in which one DCI simultaneously schedules a PDSCH and/or PUSCH of at least one serving cell is configured in each search space in a BWP of a scheduling cell is independent. Accordingly, the detecting the DCI according to the configuration information comprises detecting the DCI according to the configuration information, for each search space of a downlink BWP. Whether a scheduling mode in which one DCI simultaneously schedules a PDSCH and/or PUSCH of at least one serving cell is configured in each search space and a BWP of a scheduling cell are independent.

For example, in the above example, the UE is configured with four serving cells, namely, serving cell 1, serving cell 2, serving cell 3 and serving cell 4. The serving cell 1 is self-carrier-scheduled by the serving cell 1. The serving cell 2, the serving cell 3 and the serving cell 4 are cross-carrier-scheduled by the serving cell 1, and the serving cell 1 is configured with one downlink BWP (e.g., BWP-1).

In case that BWP-1 of the serving cell 1 is in an activation state, the UE is configured with search space-1 and search space-2 through one signaling. In this search space-1, the UE is configured to detect DCI having a DCI format DCI 1-X, where DCI 1-X is a DCI format in which one DCI schedules a PDSCH and/or PUSCH of at least one serving cell, and this DCI format (e.g., DCI 1-X) may also have other names, and the present disclosure does not limit to this. The DCI having this DCI (e.g., DCI 1-X) format may simultaneously schedule the PDSCH and/or PUSCH of at least one serving cell of the serving cell 1, the serving cell 2, the serving cell 3 and the serving cell 4. Since how to detect the DCI has been described above, it will not be repeated here.

In search space-2, the UE is configured to detect DCI having a DCI format DCI 1-1, where DCI 1-1 is a DCI format for indicating that one DCI schedules a PDSCH and/or PUSCH of one serving cell. Here, the UE is not configured to detect DCI having the DCI format DCI 1-X.

By using the above Method 2, the technical effect that can be obtained by using the above Method 1 may be achieved.

According to an embodiment, a scheduling configuration in which one DCI simultaneously schedules a PDSCH and/or PUSCH of at least one serving cell is configured for each of multiple downlink BWPs (or, a plurality of downlink BWPs). That is to say, a scheduling configuration, in which one DCI simultaneously schedules a PDSCH and/or PUSCH of at least one serving cell, configured in a search space in a BWP of each scheduling cell is independent.

For example, in the above example, the UE is configured with four serving cells, namely, serving cell 1, serving cell 2, serving cell 3 and serving cell 4 respectively, wherein, the serving cell 1 is self-carrier-scheduled by the serving cell 1. The serving cell 2, the serving cell 3 and the serving cell 4 are cross-carrier-scheduled by the serving cell 1. The serving cell 1 is configured with two downlink BWPs (e.g., BWP-1 and BWP-2), respectively. In case that BWP-1 of the serving cell 1 is in an activation state, the UE is configured with search space-1 and search space-2 through one signaling. In the search space-1 and the search space-2, the UE is configured to detect DCI having a DCI format DCI 1-X, where DCI 1-X is a DCI format for indicating that one DCI simultaneously schedules a PDSCH and/or PUSCH of at least one serving cell, and this DCI format (e.g., DCI 1-X) may also have other names, and the present disclosure does not limit to this. The DCI having the DCI format DCI 1-X may simultaneously schedule the PDSCH and/or PUSCH of at least one serving cell of the serving cell 1, the serving cell 2 and the serving cell 3.

In case that BWP-2 of the serving cell 1 is in an activation state, the UE is configured with search space-3 and search space-4 through another signaling. In this search space-3 and search space-4, the UE is configured to detect DCI having a DCI format DCI 1-X, and at this time, the DCI having the DCI format DCI 1-X may simultaneously schedule the PDSCH and/or PUSCH of at least one serving cell of the serving cell 1, the serving cell 2 and the serving cell 4. That is to say, a scheduling configuration in which the UE can simultaneously schedule the PDSCH(s) and/or PUSCH(s) of the serving cell(s) according to the detected DCI having DCI 1-X, when BWP-2 is in an activation state, may be independent from a scheduling configuration in which the UE can simultaneously schedule the PDSCH(s) and/or PUSCH(s) of the serving cell(s) according to the detected DCI having DCI 1-X, when BWP-1 is in an activation state. That is, a scheduling configuration in which one DCI simultaneously schedules a PDSCH and/or PUSCH of at least one serving cell is configured for each of multiple downlink BWPs.

In this way, according to the number of serving cells that may be scheduled by the UE when configured in subcarrier spaces of different BWPs, the appropriate number of serving cells that may be scheduled are selected, so as to save resources occupied by a PDCCH as much as possible.

According to an embodiment, a scheduling configuration in which one DCI simultaneously schedules a PDSCH and/or PUSCH of at least one serving cell is configured for each search space of a downlink BWP. That is to say, a scheduling configuration, in which one DCI simultaneously schedules a PDSCH and/or PUSCH of at least one serving cell, configured in each search space in a BWP of a scheduling cell is independent.

For example, in the above example, the UE is configured with four serving cells, namely, serving cell 1, serving cell 2, serving cell 3 and serving cell 4 respectively, wherein, the serving cell 1 is self-carrier-scheduled by the serving cell 1; the serving cell 2, the serving cell 3 and the serving cell 4 are cross-carrier-scheduled by the serving cell 1, and the serving cell 1 is configured with one downlink BWP. When this downlink BWP is in an activation state, the UE is configured with search space-1 through one signaling, wherein, in this search space-1, the UE is configured to detect DCI having a DCI format DCI 1-X, where DCI 1-X is a DCI format for indicating that one DCI schedules a PDSCH and/or PUSCH of at least one serving cell, and this DCI format may also have other names, and the present disclosure does not limit to this. The DCI having the DCI format DCI 1-X may simultaneously schedule the PDSCH and/or PUSCH of at least one serving cell of the serving cell 1, the serving cell 2 and the serving cell 3.

The UE is configured with search space-2 through another signaling. In this search space-2, the UE is configured to detect DCI having a DCI format DCI 1-X, where DCI 1-X is a DCI format in which one DCI schedules a PDSCH and/or PUSCH of at least one serving cell, and this DCI format may also have other names, and the present disclosure does not limit to this. The DCI having the DCI format DCI 1-X may simultaneously schedule the PDSCH and/or PUSCH of at least one serving cell of the serving cell 1, the serving cell 2 and the serving cell 4. That is to say, a scheduling configuration in which the UE can simultaneously schedule the PDSCH(s) and/or PUSCH(s) of the serving cell(s) according to the detected DCI having DCI 1-X, in search space-2, may be independent from a scheduling configuration in which the UE can simultaneously schedule the PDSCH(s) and/or PUSCH(s) of the serving cell(s) according to the detected DCI having DCI 1-X, in search space-1. That is, a scheduling configuration in which one DCI simultaneously schedules a PDSCH and/or PUSCH of at least one serving cell is configured for each search space of a downlink BWP.

In this way, according to the number of serving cells that may be scheduled by the UE when configured in subcarrier spaces of different BWPs, the appropriate number of serving cells that may be scheduled are selected, so as to save resources occupied by a PDCCH as much as possible.

At step S430, the PDSCH and/or PUSCH scheduled by the detected DCI is received, based on (or, according to) the detected DCI. For example, the UE may receive data on the PDSCH based on the detected DCI. For example, the UE may transmit data on the PUSCH based on the detected DCI.

For example, in the above example, when PDSCHs and/or PUSCHs of serving cell 1, serving cell 2 and serving cell 3 are scheduled by the DCI detected at step S420, the UE may receive the PDSCHs and/or PUSCHs of the serving cell 1, the serving cell 2 and the serving cell 3. Since the process of scheduling a PDSCH and/or PUSCH using DCI is known to those skilled in the art, it will not be described here.

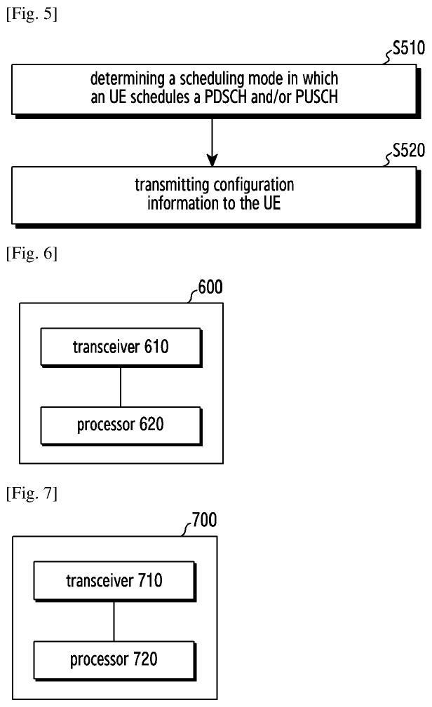

FIG. 5 is a flowchart illustrating a method performed by a base station in a communication system according to an exemplary embodiment of the present disclosure.

Referring to FIG. 5, at step S510, a scheduling mode in which an UE schedules a PDSCH and/or PUSCH is determined. The scheduling mode may include a first scheduling mode for representing (or, indicating) that one DCI schedules a PDSCH and/or PUSCH of one serving cell, and/or a second scheduling mode for representing (or, indicating) that one DCI simultaneously schedules a PDSCH and/or PUSCH of at least one serving cell. By using the second scheduling mode in which one DCI simultaneously schedules a PDSCH and/or PUSCH of at least one serving cell, the resources occupied by a PDCCH may be saved as much as possible.

According to an embodiment, the scheduling mode may be determined based on information of the wireless channel environment of the UE. That is, the base station may determine whether the scheduling mode is the first scheduling mode or the second scheduling mode. For example, the scheduling mode may be determined according to the Channel Quality Information (CQI) fed back by the UE. For example, if it is determined that PDCCH resources are currently wasted according to the information of the wireless channel environment, the scheduling mode may be determined as the second scheduling mode. According to whether the UE has a requirement for one DCI to simultaneously schedule a PDSCH and/or PUSCH of at least one serving cell, the base station determines whether to configure the UE to detect a DCI format in which one DCI simultaneously schedules a PDSCH and/or PUSCH of at least one serving cell, so as to save resources occupied by a PDCCH as much as possible.

At step S520, the configuration information is transmitted to the UE. The configuration information comprises information for indicating the scheduling mode. For example, the base station may transmit the configuration information to the UE.

According to an embodiment, the configuration information further comprises the number of serving cells whose PDSCHs and/or PUSCHs are simultaneously scheduled by one DCI, and/or DCI format information. The DCI format information includes format information for indicating a DCI format.

According to an embodiment, in case that the scheduling mode is the second scheduling mode, the format information is used to indicate a DCI format in which one DCI simultaneously schedules the PDSCHs and/or PUSCHs of the number of serving cells. That is to say, at this time, the based station may transmit the above configuration information to the UE, so that the UE can further obtain the above number and the above DCI format information from the configuration information, so as to facilitate DCI detection by UE.

According to an embodiment, in case that the based station determines that the scheduling mode is the first scheduling mode, the configuration information does not comprise the number of serving cells whose PDSCHs and/or PUSCHs are simultaneously scheduled by one DCI, but includes DCI format information. The format information included in the DCI format information indicates a DCI format in which one DCI schedules one PDSCH and/or PUSCH.

According to an embodiment, regardless of whether the scheduling mode is the first scheduling mode or the second scheduling mode, the DCI format information may further include a payload size of the DCI format. The payload size may be used by UE for the detection operation in step S420 described above.

According to an embodiment, in case that the based station determines that the scheduling mode is the second scheduling mode, the DCI format information may not include the payload size of the DCI format, and at this time, at the UE side, the payload size of the DCI format may be calculated, according to the number of serving cells whose PDSCHs and/or PUSCHs are simultaneously scheduled by one DCI, included in the configuration information. The number of serving cells whose PDSCHs and/or PUSCHs are simultaneously scheduled by one DCI may be at least one of: the number of serving cells configured for the UE, the maximum number of serving cells configured for the UE, and a range of the number of serving cells configured for the UE. Since this has been described in detail above, it will not be repeated here.

According to an embodiment, the method further comprises configuring and transmitting the DCI according to the transmitted configuration information, so that the UE receives a PDSCH and/or PUSCH scheduled by the DCI.

According to an embodiment, there are two different methods to configure and transmit DCI with the above DCI format. The two methods described below is coupled with each other. That is the base station is configured to configure and transmit DCI with the above DCI format based on the Method 1 and/or Method 2.

### Method 1

Whether a scheduling mode in which one DCI simultaneously schedules a PDSCH and/or PUSCH of at least one serving cell is configured in a search space in a BWP of each scheduling cell is independent. Accordingly, the DCI configured and transmitted according to the configuration information, for each of multiple downlink BWPs.

For example, the UE is configured with four serving cells, namely, serving cell 1, serving cell 2, serving cell 3 and serving cell 4 respectively. The serving cell 1 is self-carrier-scheduled by the serving cell 1; the serving cell 2, the serving cell 3 and the serving cell 4 are cross-carrier-scheduled by the serving cell 1. The based station configures multiple BWPs for the serving cell 1, for example, configures two downlink BWPs, i.e., BWP-1 and BWP-2, respectively. In case that BWP-1 of the serving cell 1 is in an activation state, the based station configures multiple search spaces for the UE through one signaling, such as search space-1 and search space-2. The UE is configured by the based station to detect DCI having a DCI format DCI 1-X in this search space-1 and search space-2. DCI 1-X is a DCI format in which one DCI simultaneously schedules a PDSCH and/or PUSCH of at least one serving cell, and this DCI format may also have other names, and the present disclosure does not limit to this. The DCI having this DCI (e.g., DCI 1-X) format may simultaneously schedule the PDSCH and/or PUSCH of at least one serving cell of the serving cell 1, the serving cell 2, the serving cell 3 and the serving cell 4.

In case that BWP-2 of the serving cell 1 is in an activation state, the based station configures search space-3 and search space-4 for the UE through another signaling, and the UE is configured by the based station to detect DCI having a DCI format DCI 1-1 in search space-3 and search space-4, where DCI 1-1 is a DCI format in which one DCI schedules a PDSCH and/or PUSCH of one serving cell. Here, the UE is not configured by the based station to detect the DCI format DCI 1-X.

By using the above Method 1, according to whether the UE has a requirement for one DCI to simultaneously schedule PDSCHs and/or PUSCHs of multiple serving cells, the base station determines whether to configure the UE to detect a DCI format in which one DCI simultaneously schedules the PDSCHs and/or PUSCHs of the multiple serving cells, so as to save resources occupied by a PDCCH as much as possible. This is because in case that the DCI format in which one DCI simultaneously schedules the PDSCH and/or PUSCH of the at least one serving cell is used to schedule the PDSCH and/or PUSCH of the at least one serving cell, the resources occupied by the PDCCH may be saved, and in case that the DCI format in which one DCI simultaneously schedules the PDSCH and/or PUSCH of the at least one serving cell is used to schedule a PDSCH and/or PUSCH of one serving cell, the resources occupied by the PDCCH are wasted.

### Method 2

Whether a scheduling mode in which one DCI simultaneously schedules a PDSCH and/or PUSCH of at least one serving cell is configured in each search space in a BWP of a scheduling cell is independent. Accordingly, the DCI is configured and transmitted according to the configuration information, for each search space of a downlink BWP.

For example, the UE is configured with four serving cells, namely, serving cell 1, serving cell 2, serving cell 3 and serving cell 4 respectively, wherein, the serving cell 1 is self-carrier-scheduled by the serving cell 1; the serving cell 2, the serving cell 3 and the serving cell 4 are cross-carrier-scheduled by the serving cell 1, wherein, the based station configures one downlink BWP for the serving cell 1, i.e., BWP-1. When BWP-1 of the serving cell 1 is in an activation state, the based station configures search space-1 and search space-2 for the UE through one signaling, wherein, the UE is configured by the based station to detect DCI having a DCI format DCI 1-X in this search space-1, where DCI 1-X is a DCI format in which one DCI simultaneously schedules a PDSCH and/or PUSCH of at least one serving cell, and this DCI format may also have other names, and the present disclosure does not limit to this. The DCI having this DCI format may simultaneously schedule the PDSCH and/or PUSCH of at least one serving cell of the serving cell 1, the serving cell 2, the serving cell 3 and the serving cell 4. Since how to detect the DCI has been described above, it will not be repeated here.

In search space-2, the UE is configured by the based station to detect DCI having a DCI format DCI 1-1, where DCI 1-1 is a DCI format for indicating that one DCI schedules a PDSCH and/or PUSCH of one serving cell. Here, the UE is not configured by the based station to detect DCI having the DCI format DCI 1-X.

Herein, by using the above Method 2, the technical effect that can be obtained by using the above Method I may be achieved.

Besides, in an exemplary embodiment of the present disclosure, a scheduling configuration in which one DCI simultaneously schedules a PDSCH and/or PUSCH of at least one serving cell is configured for each of multiple downlink BWPs. That is to say, a scheduling configuration, in which one DCI simultaneously schedules a PDSCH and/or PUSCH of at least one serving cell, configured in a search space in a BWP of each scheduling cell is independent.

For example, the UE is configured with four serving cells, namely, serving cell 1, serving cell 2, serving cell 3 and serving cell 4 respectively, wherein, the serving cell 1 is self-carrier-scheduled by the serving cell 1; the serving cell 2, the serving cell 3 and the serving cell 4 are cross-carrier-scheduled by the serving cell 1, wherein the based station configures two downlink BWPs for the serving cell 1, i.e., BWP-1 and BWP-2, respectively. When BWP-1 of the serving cell 1 is in an activation state, the based station configures search space-1 and search space-2 for the UE through one signaling, wherein, the UE is configured by the based station to detect DCI having a DCI format DCI 1-X in this search space-1 and search space-2, where DCI 1-X is a DCI format in which one DCI simultaneously schedules a PDSCH and/or PUSCH of at least one serving cell, and this DCI format may also have other names, and the present disclosure does not limit to this. The DCI having the DCI format DCI 1-X may simultaneously schedule the PDSCH and/or PUSCH of at least one serving cell of the serving cell 1, the serving cell 2 and the serving cell 3.

When BWP-2 of the serving cell 1 is in an activation state, the based station configures search space-3 and search space-4 for the UE through another signaling. The UE is configured by the based station to detect DCI having a DCI format DCI 1-X in this search space-3 and search space-4, and at this time, the DCI having the DCI format DCI 1-X may simultaneously schedule the PDSCH and/or PUSCH of at least one serving cell of the serving cell 1, the serving cell 2 and the serving cell 4. That is to say, a scheduling configuration, in which one DCI may simultaneously schedule a PDSCH and/or PUSCH of at least one serving cell, configured for BWP-2, is independent from a scheduling configuration, in which one DCI may simultaneously schedule a PDSCH and/or PUSCH of at least one serving cell, configured for BWP-1. That is to say, the based station may configure a scheduling configuration in which one DCI simultaneously schedules a PDSCH and/or PUSCH of at least one serving cell, for each downlink BWP.

In this way, according to the number of serving cells that may be scheduled by the UE when configured in subcarrier spaces of different BWPs, the appropriate number of serving cells that may be scheduled are selected, so as to save resources occupied by a PDCCH as much as possible.

Besides, in an exemplary embodiment of the present disclosure, a scheduling configuration in which one DCI simultaneously schedules a PDSCH and/or PUSCH of at least one serving cell is configured for each search space of a downlink BWP. That is to say, a scheduling configuration, in which one DCI simultaneously schedules a

PDSCH and/or PUSCH of at least one serving cell, configured in each search space in a BWP of a scheduling cell is independent.

For example, the UE is configured with four serving cells, namely, serving cell 1, serving cell 2, serving cell 3 and serving cell 4 respectively, wherein, the serving cell 1 is self-carrier-scheduled by the serving cell 1; the serving cell 2, the serving cell 3 and the serving cell 4 are cross-carrier-scheduled by the serving cell 1, and the serving cell 1 is configured with one downlink BWP. When this downlink BWP is in an activation state, the based station configures search space-1 for the UE through one signaling, wherein, the UE is configured by the based station to detect DCI having a DCI format DCI 1-X in this search space-1, where DCI 1-X is a DCI format in which one DCI schedules a PDSCH and/or PUSCH of at least one serving cell, and this DCI format may also have other names, and the present disclosure does not limit to this. The DCI having the DCI format DCI 1-X may simultaneously schedule the PDSCH and/or PUSCH of at least one serving cell of the serving cell 1, the serving cell 2 and the serving cell 3.

The based station configures search space-2 for the UE through another signaling. The UE is configured by the based station to detect DCI having a DCI format DCI 1-X in this search space-2, where DCI 1-X is a DCI format in which one DCI schedules a PDSCH and/or PUSCH of at least one serving cell, and this DCI format may also have other names, and the present disclosure does not limit to this. The DCI having the DCI format DCI 1-X may simultaneously schedule the PDSCH and/or PUSCH of at least one serving cell of the serving cell 1, the serving cell 2 and the serving cell 4. That is to say, a scheduling configuration, in which one DCI simultaneously schedule a PDSCH and/or PUSCH of at least one serving cell, configured for search space-2, may be independent from a scheduling configuration, in which one DCI simultaneously schedule a PDSCH and/or PUSCH of at least one serving cell, configured for search space-1. That is to say, the base station configures a scheduling configuration in which one DCI simultaneously schedules a PDSCH and/or PUSCH of at least one serving cell, for each search space of one downlink BWP.

In this way, according to the number of serving cells that may be scheduled by the UE when configured in subcarrier spaces of different BWPs, the appropriate number of serving cells that may be scheduled are selected, so as to save resources occupied by a PDCCH as much as possible.

According to an embodiment, a method performed by an user equipment (UE) in a communication system is provided. The method comprises receiving configuration information transmitted by a base station, the configuration information comprising information for indicating a scheduling mode of a PDSCH and/or PUSCH, detecting downlink control information (DCI) according to the configuration information, receiving the PDSCH and/or PUSCH scheduled by the detected DCI, according to the detected DCI. wherein, the scheduling mode includes a first scheduling mode for representing that one DCI schedules a PDSCH and/or PUSCH of one serving cell, and/or a second scheduling mode for representing that one DCI simultaneously schedules a PDSCH and/or PUSCH of at least one serving cell.

The detecting the DCI according to the configuration information comprises detecting the DCI according to the configuration information, for each of multiple downlink BWPs.

The detecting the DCI according to the configuration information comprises detecting the DCI according to the configuration information, for each search space of a downlink BWP.

A scheduling configuration in which one DCI simultaneously schedules a PDSCH and/or PUSCH of at least one serving cell is configured for each of the multiple downlink BWPs.

A scheduling configuration in which one DCI simultaneously schedules a PDSCH and/or PUSCH of at least one serving cell is configured for each search space of the downlink BWP.

The configuration information further comprises: the number of serving cells whose PDSCHs and/or PUSCHs are simultaneously scheduled by one DCI, and/or DCI format information;

The DCI format information includes format information for indicating a DCI format in which one DCI simultaneously schedules the PDSCHs and/or PUSCHs of the number of serving cells.

The number of serving cells whose PDSCHs and/or PUSCHs are simultaneously scheduled by one DCI is at least one of: the number of serving cells configured for the UE, the maximum number of serving cells configured for the UE, and a range of the number of serving cells configured for the UE.

The detecting the DCI according to the configuration information comprises calculating a payload size of the DCI format, according to the number of serving cells whose PDSCHs and/or PUSCHs are simultaneously scheduled by one DCI included in the configuration information and detecting the DCI having the DCI format in a search space, according to the payload size of the DCI format and the format information.

According to an embodiment, a method performed by a base station in a communication system is provided. The method comprises determining a scheduling mode in which an user equipment (UE) schedules a PDSCH and/or PUSCH, transmitting configuration information to the UE, the configuration information comprising information for indicating the scheduling mode. Wherein, the scheduling mode includes a first scheduling mode for representing that one DCI schedules a PDSCH and/or PUSCH of one serving cell, and/or a second scheduling mode for representing that one DCI simultaneously schedules a PDSCH and/or PUSCH of at least one serving cell.

The method further comprises configuring and transmitting DCI according to the configuration information, for each of multiple downlink BWPs.

The method further comprises configuring and transmitting DCI according to the configuration information, for each search space of a downlink BWP.

A scheduling configuration in which one DCI simultaneously schedules a PDSCH and/or PUSCH of at least one serving cell is configured for each of the multiple downlink BWPs.

A scheduling configuration in which one DCI simultaneously schedules a PDSCH and/or PUSCH of at least one serving cell is configured for each search space of the downlink BWP.

The configuration information further comprises: the number of serving cells whose PDSCHs and/or PUSCHs are simultaneously scheduled by one DCI, and/or DCI format information;

The DCI format information includes format information for indicating a DCI format in which one DCI simultaneously schedules the PDSCHs and/or PUSCHs of the number of serving cells.

The number of serving cells whose PDSCHs and/or PUSCHs are simultaneously scheduled by one DCI is at least one of: the number of serving cells configured for the UE, the maximum number of serving cells configured for the UE, and a range of the number of serving cells configured for the UE.

According to an embodiment, a user equipment is provided. The UE comprises a transceiver and a processor coupled to the transceiver and configured to perform a method as described above.

According to an embodiment, a base station is provided. The base station comprises a transceiver and a processor, coupled to the transceiver and configured to perform a method as described above.

According to an embodiment, a computer-readable storage medium storing instructions is provided. The instructions, when run by at least one processor, cause the at least one processor to perform a method as claimed in any one of claims 1 to 8 or a method as described above.

FIG. 6 is a block diagram illustrating an user equipment (UE) 600 according to an exemplary embodiment of the present disclosure.

As shown in FIG. 6, the UE 600 includes a transceiver 610 and a processor 620, wherein the processor 620 is coupled to the transceiver 610 and configured to perform the method described above with reference to FIG. 4. Details of the operations of the method may refer to the description of FIG. 4 and are not repeated here.

FIG. 7 is a block diagram illustrating a base station 700 according to an exemplary embodiment of the present disclosure.

As shown in FIG. 7, the base station 700 includes a transceiver 710 and a processor 720, wherein the processor 720 is coupled to the transceiver 710 and configured to perform the method described above with reference to FIG. 5. Details of the operations of the method may refer to the description of FIG. 5 and are not repeated here.

According to the embodiments of the present disclosure, an electronic apparatus is further provided, including: at least one processor; and at least one memory storing computer-executable instructions, wherein the computer-executable instructions, when run by the at least one processor, cause the at least one processor to perform any one of the method as described above with reference to FIG. 4 and the method as described above with reference to FIG. 5.

According to an embodiment, a method performed by a user equipment (UE) in a wireless communication system is provided. The method comprises receiving, from a base station, first downlink control information (DCI) for scheduling multiple physical downlink shared channels (PDSCHs) on multiple cells based on a first search space set and receiving, from the base station, the multiple PDSCHs on the multiple cells based on the first DCI. The first search space set for the first DCI is different from a search space set for a DCI scheduling a PDSCH on one cell.

The method comprises receiving, from the base station, a second DCI for scheduling multiple physical uplink shared channels (PUSCHs) on multiple cells based on a second search space set and transmitting, to the base station, the multiple PUSCHs on the multiple cells based on the second DCI. The second search space set for the second DCI is different from a search space set for a DCI scheduling a PUSCH on one cell.

The first search space set and the second search space set are different from each other.

The method comprises receiving, from the base station, information configuring the first search space set and the second search space set for the UE and information on a maximum number of the multiple cells for the multiple PDSCHs.

According to an embodiment, a user equipment (UE) in a wireless communication system is provided. The UE comprises a transceiver and a controller coupled with the transceiver and configured to receive, from a base station, first downlink control information (DCI) for scheduling multiple physical downlink shared channels (PDSCHs) on multiple cells based on a first search space set and receive, from the base station, the multiple PDSCHs on the multiple cells based on the first DCI. The first search space set for the first DCI is different from a search space set for a DCI scheduling a PDSCH on one cell.

The controller is further configured to receive, from the base station, a second DCI for scheduling multiple physical uplink shared channels (PUSCHs) on multiple cells based on a second search space set and transmit, to the base station, the multiple PUSCHs on the multiple cells based on the second DCI. The second search space set for the second DCI is different from a search space set for a DCI scheduling a PUSCH on one cell.

The first search space set and the second search space set are different from each other.

The controller is further configured to receive, from the base station, information configuring the first search space set and the second search space set for the UE and information on a maximum number of the multiple cells for the multiple PDSCHs.

According to an embodiment, a method performed by a base station in a wireless communication system is provided. The method comprises transmitting, to a user equipment (UE), first downlink control information (DCI) for scheduling multiple physical downlink shared channels (PDSCHs) on multiple cells and transmitting, to the UE, the multiple PDSCHs on the multiple cells based on the first DCI. A first search space set for the first DCI is different from a search space set for a DCI scheduling a PDSCH on one cell.

The method comprises transmitting, to the UE, a second DCI for scheduling multiple physical uplink shared channels (PUSCHs) on multiple cells and receiving, from the UE, the multiple PUSCHs on the multiple cells based on the second DCI. A second search space set for the second DCI is different from a search space set for a DCI scheduling a PUSCH on one cell.

The first search space set and the second search space set are different from each other.

The method comprises transmitting, to the UE, information configuring the first search space set and the second search space set for the UE and information on a maximum number of the multiple cells for the multiple PDSCHs.

According to an embodiment, a base station in a wireless communication system is provided. The base station comprises a transceiver and a controller coupled with the transceiver and configured to transmit, to a user equipment (UE), first downlink control information (DCI) for scheduling multiple physical downlink shared channels (PDSCHs) on multiple cells and transmit, to the UE, the multiple PDSCHs on the multiple cells based on the first DCI. A first search space set for the first DCI is different from a search space set for a DCI scheduling a PDSCH on one cell.

The controller is further configured to transmit, to the UE, a second DCI for scheduling multiple physical uplink shared channels (PUSCHs) on multiple cells and receive, from the UE, the multiple PUSCHs on the multiple cells based on the second DCI. A second search space set for the second DCI is different from a search space set for a DCI scheduling a PUSCH on one cell.

The first search space set and the second search space set are different from each other.

As an example, the electronic apparatus may be a PC computer, a tablet device, a personal digital assistant, a smartphone, or any other device capable of executing the above instruction set. Here, the electronic apparatus does not have to be a single electronic apparatus, but may also be any set of devices or circuits capable of executing the above instructions (or instruction set) individually or jointly. The electronic apparatus may also be a part of an integrated control system or system manager, or may be configured as a portable electronic apparatus that interfaces locally or remotely (e.g., via wireless transmission).

In the electronic apparatus, the processor may include a central processing unit (CPU), graphics processing unit (GPU), programmable logic device, special purpose processor system, microcontroller or microprocessor. By way of example and not limitation, the processor may also include analog processors, digital processors, microprocessors, multi-core processors, processor arrays, network processors, and the like.

The processor may execute instructions or code stored in the memory, which may also store data. Instructions and data may also be sent and received over a network via a network interface, which may employ any known transport protocol.

The memory may be integrated with the processor, e.g., a RAM or flash memory is arranged within an integrated circuit microprocessor or the like. Additionally, the memory may include a separate device such as an external disk drive, storage array, or any other storage device that may be used by a database system. The memory and the processor may be operatively coupled, or may communicate with each other, e.g., through I/O ports, network connections, etc., to enable the processor to read files stored in the memory.

In addition, the electronic apparatus may also include video displays (e.g. liquid crystal display) and user interaction interfaces (e.g. keyboard, mouse, touch input device, etc.). All components of the electronic apparatus may be connected to each other via a bus and/or a network.

According to an embodiment of the present disclosure, a computer readable storage medium storing instructions is also provided. The instructions, when executed by at least one processor, causes the at least one processor to perform any of the method described with reference to FIG. 4 and the method as described with reference to FIG. 5 according to the exemplary embodiments of the present disclosure. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device, such as client, host, proxy device, server, etc. In addition, in one example, the computer programs and any associated data, data files, and data structures are distributed on a networked computer system, so that the computer programs and any associated data, data files, and data structures are stored, accessed and executed through one or more processors or computers in a distributed manner.

It should be noted that the terms “first”, “second”, “third”, “fourth”, “1”, “2”, etc. (if present) used in the specification and claims and the accompanying drawings above of the present disclosure are used to distinguish similar objects and are not necessary for describing a particular order or sequence. It should be understood that the data so used is interchangeable in appropriate cases so that the embodiments of the present disclosure described herein may be implemented in an order other than that illustrated or described herein.

It should be understood that while the flowcharts of the embodiments of the present disclosure indicate the individual operational steps by arrows, the implementation order of these steps is not limited to the order indicated by the arrows. Unless explicitly stated herein, in some implementation scenarios of the embodiments of the present disclosure, the implementation steps in the respective flowcharts may be performed in other orders as desired. In addition, some or all of the steps in each flowchart may include multiple sub-steps or multiple stages based on actual implementation scenarios. Some or all of these sub-steps or stages may be executed at the same moment, and each of these sub-steps or stages may also be executed separately at different moments. In the scenarios where the execution moments are different, the order of execution of these sub-steps or stages may be flexibly configured according to the needs, and the embodiments of the present disclosure are not limited thereto.

The above description is only an optional implementation of part of the implementation scenarios of the present disclosure. It should be noted that for those ordinary skill in the art, other similar means of implementation based on the technical idea of the present disclosure, without departing from the technical idea of the present disclosure, also fall within the scope of protection of the embodiments of the present disclosure.

1. A method performed by a user equipment (UE) in a wireless communication system, the method comprising:
receiving, from a base station, first downlink control information (DCI) for scheduling multiple physical downlink shared channels (PDSCHs) on multiple cells based on a first search space set; and
receiving, from the base station, the multiple PDSCHs on the multiple cells based on the first DCI,
wherein the first search space set for the first DCI is different from a search space set for a DCI scheduling a PDSCH on one cell.

2. The method of claim 1, further comprising:
receiving, from the base station, a second DCI for scheduling multiple physical uplink shared channels (PUSCHs) on multiple cells based on a second search space set; and
transmitting, to the base station, the multiple PUSCHs on the multiple cells based on the second DCI,
wherein the second search space set for the second DCI is different from a search space set for a DCI scheduling a PUSCH on one cell.

3. The method of claim 2, wherein the first search space set and the second search space set are different from each other.

4. The method of claim 2, further comprising:
receiving, from the base station, information configuring the first search space set and the second search space set for the UE and information on a maximum number of the multiple cells for the multiple PDSCHs.

5. A user equipment (UE) in a wireless communication system, the UE comprising:
a transceiver; and
a controller coupled with the transceiver and configured to:
receive, from a base station, first downlink control information (DCI) for scheduling multiple physical downlink shared channels (PDSCHs) on multiple cells based on a first search space set; and
receive, from the base station, the multiple PDSCHs on the multiple cells based on the first DCI,
wherein the first search space set for the first DCI is different from a search space set for a DCI scheduling a PDSCH on one cell.

6. The UE of claim 5, wherein the controller is further configured to:
receive, from the base station, a second DCI for scheduling multiple physical uplink shared channels (PUSCHs) on multiple cells based on a second search space set; and
transmit, to the base station, the multiple PUSCHs on the multiple cells based on the second DCI,
wherein the second search space set for the second DCI is different from a search space set for a DCI scheduling a PUSCH on one cell.

7. The UE of claim 6, wherein the first search space set and the second search space set are different from each other.

8. The UE of claim 6, wherein the controller is further configured to:
receive, from the base station, information configuring the first search space set and the second search space set for the UE and information on a maximum number of the multiple cells for the multiple PDSCHs.

9. A method performed by a base station in a wireless communication system, the method comprising:
transmitting, to a user equipment (UE), first downlink control information (DCI) for scheduling multiple physical downlink shared channels (PDSCHs) on multiple cells; and
transmitting, to the UE, the multiple PDSCHs on the multiple cells based on the first DCI,
wherein a first search space set for the first DCI is different from a search space set for a DCI scheduling a PDSCH on one cell.

10. The method of claim 9, further comprising:
transmitting, to the UE, a second DCI for scheduling multiple physical uplink shared channels (PUSCHs) on multiple cells; and
receiving, from the UE, the multiple PUSCHs on the multiple cells based on the second DCI,
wherein a second search space set for the second DCI is different from a search space set for a DCI scheduling a PUSCH on one cell.

11. The method of claim 10, wherein the first search space set and the second search space set are different from each other.

12. The method of claim 10, further comprising:
transmitting, to the UE, information configuring the first search space set and the second search space set for the UE and information on a maximum number of the multiple cells for the multiple PDSCHs.

13. A base station in a wireless communication system, the base station comprising:
a transceiver; and
a controller coupled with the transceiver and configured to:
transmit, to a user equipment (UE), first downlink control information (DCI) for scheduling multiple physical downlink shared channels (PDSCHs) on multiple cells; and
transmit, to the UE, the multiple PDSCHs on the multiple cells based on the first DCI,
wherein a first search space set for the first DCI is different from a search space set for a DCI scheduling a PDSCH on one cell.

14. The base station of claim 13, wherein the controller is further configured to:
transmit, to the UE, a second DCI for scheduling multiple physical uplink shared channels (PUSCHs) on multiple cells; and
receive, from the UE, the multiple PUSCHs on the multiple cells based on the second DCI,
wherein a second search space set for the second DCI is different from a search space set for a DCI scheduling a PUSCH on one cell.

15. The base station of claim 14, wherein the first search space set and the second search space set are different from each other.
